(19) United States
(12) Patent Application Publication
(10) Pub. No.: US 2026/0145973 A1
(43) Pub. Date: May 28, 2026

(54) RECOVERY OF CARBON DIOXIDE FROM PRODUCED WATER TO NEUTRALIZE LIQUID BRINE

(71) Applicant: Renovo Resources LLC, Irvine, CA (US)

(72) Inventors: Brad Biagini, Wexford, PA (US); Lnsp Nagghappan, Irvine, CA (US); Gregory F. Wilbur, Murray, UT (US)

(21) Appl. No.: 19/400,857

(22) Filed: Nov. 25, 2025

Related U.S. Application Data
(60) Provisional application No. 63/725,193, filed on Nov. 26, 2024.

(51) Int. Cl. C02F 1/66; B01D 53/52; B01D 53/62; B01D 53/96

(52) U.S. Cl. CPC C02F 1/66; B01D 53/526; B01D 53/62; B01D 53/96; B01D 2257/304; B01D 2257/504

(57) ABSTRACT

A method of utilizing a carbon dioxide-rich gas stream, generated during treatment of produced water, to neutralize an alkaline liquid brine stream, includes capturing, as stored carbon dioxide-rich gas, the carbon dioxide-rich gas stream as an off-gas or waste gas from a gas treatment system and directing the carbon dioxide-rich gas stream to a storage vessel. The stored carbon dioxide-rich gas is re-pressurized as re-pressurized carbon dioxide-rich gas and injected into an alkaline liquid brine stream. The re-pressurized carbon dioxide-rich gas is utilized to achieve neutralization, or partial neutralization, of the alkaline liquid brine stream as a neutralized alkaline liquid brine stream.

### CROSS-REFERENCE TO RELATED APPLICATIONS

This application claims the benefit of priority to U.S. Application No. 63/725,193, filed on November 26, 2024, the contents of which are hereby incorporated by reference.

### BACKGROUND

Large volumes of produced water are generated as a by-product of oil and gas exploration and production. The produced water typically contains dissolved gases which include carbon dioxide and hydrogen sulfide and also alkalinity in the form of bicarbonate and carbonate ions, and the speciation of the total alkalinity within the produced water is a function of the power of hydrogen (pH) of the produced water. A portion of the produced water is minimally treated and recycled for steam generation or water flooding. The excess produced water is often disposed by injection into underground wells. Due to the many challenges associated with injection, there is a need to develop reliable alternate solutions for disposal of produced water and to minimize injection volumes, for example treatment of produced water for beneficial reuse to minimize injection volumes. When treating produced water for beneficial reuse, the volume of liquid requiring underground injection is reduced, but beneficial reuse processes typically generate a liquid brine stream that requires injection. In some cases, the brine stream that needs to be injected exists at an alkaline pH condition, requiring neutralization of the brine stream prior to injection to prevent scaling or corrosion. However, neutralization of an alkaline brine requires an acid, which can result in significant additional operating costs in the form of chemical purchases, specifically when the liquid brine waste stream is highly alkaline and of substantial volume. Moreover, certain dissolved gases in produced water, such as carbon dioxide, are typically released into the atmosphere as a greenhouse gas.

### SUMMARY

The present disclosure describes recovery of carbon dioxide from produced water to neutralize liquid brine.

In an implementation, a method of utilizing a carbon dioxide-rich gas stream, generated during treatment of produced water, to neutralize an alkaline liquid brine stream, comprising: capturing, as stored carbon dioxide-rich gas, the carbon dioxide-rich gas stream as an off-gas or waste gas from a gas treatment system and directing the carbon dioxide-rich gas stream to a storage vessel; re-pressurizing, as re-pressurized carbon dioxide-rich gas, the stored carbon dioxide-rich gas and injecting the re-pressurized carbon dioxide-rich gas into an alkaline liquid brine stream; and utilizing the re-pressurized carbon dioxide-rich gas to achieve neutralization, or partial neutralization, of the alkaline liquid brine stream as a neutralized alkaline liquid brine stream.

In an implementation, a method of sequestering hydrogen sulfide that is present in a carbon dioxide-rich gas stream that is utilized for neutralization of an alkaline liquid brine stream, comprising: capturing, as stored carbon dioxide-rich gas, the hydrogen sulfide, along with the carbon dioxide-rich gas stream as an off-gas or waste gas from a gas treatment system and directing the hydrogen sulfide, along with the carbon dioxide-rich gas stream to a storage vessel; and re-pressurizing, as re-pressurized carbon dioxide-rich gas, the stored carbon dioxide-rich gas, which contains hydrogen sulfide, and injecting the re-pressurized carbon dioxide-rich gas into an alkaline liquid brine stream.

In an implementation, a method of sequestering volatile organic compounds that are present in a carbon dioxide-rich gas stream that is utilized for neutralization of an alkaline liquid brine stream, comprising: capturing, as stored carbon dioxide-rich gas, the volatile organic compounds, along with the carbon dioxide-rich gas stream as an off-gas or waste gas from a gas treatment system and directing the volatile organic compounds, along with the carbon dioxide-rich gas stream to a storage vessel; and re-pressurizing, as re-pressurized carbon dioxide-rich gas, the stored carbon dioxide-rich gas, which contains volatile organic compounds, and injecting the re-pressurized carbon dioxide-rich gas into the alkaline liquid brine stream.

The subject matter described in this specification can be implemented to realize one or more of the following advantages. First, the described approach is a system and process that provides a cost-effective approach for capturing carbon dioxide and utilizing the carbon dioxide to achieve neutralization of an alkaline liquid brine stream prior to disposal. Second, reduction of a quantity of acid required for neutralization of liquid brine can significantly lower annual chemical and operating costs for a treatment facility. Third, the quantity of carbon dioxide gas generated in the produced water treatment may contribute significantly to greenhouse gas emissions if the carbon dioxide is not captured and either sequestered or utilized within the process. Capturing the carbon dioxide-rich gas and utilizing it within the treatment process to achieve neutralization eliminates or reduces these potential emissions. Fourth, sequestration of hydrogen sulfide and volatile organic compounds in an alkaline liquid brine, along with the carbon dioxide, allows for the avoidance of additional capital investments to remove these contaminants in a vapor-phase.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a table illustrating an example characterization for an alkaline liquid brine stream, carbon dioxide-rich gas stream, and neutralized brine stream generated from treatment of produced water, according to an implementation of the present disclosure.

FIG. 2 is a high-level box diagram illustrating a method for utilizing carbon dioxide-rich gas as a neutralizing acid for liquid brine streams generated during the treatment of produced water for beneficial reuse, according to an implementation of the present disclosure.

FIG. 3 is a flowchart illustrating an example of a method for recovery of carbon dioxide from produced water to neutralize liquid brine, according to an implementation of the present disclosure.

FIG. 4 is a flowchart illustrating an example of a method for recovery of carbon dioxide and hydrogen sulfide from produced water to neutralize liquid brine, according to an implementation of the present disclosure.

FIG. 5 is a flowchart illustrating an example of a method for recovery of carbon dioxide and volatile organic compounds from produced water to neutralize liquid brine, according to an implementation of the present disclosure.

Like reference numbers and designations in the various drawings indicate like elements.

### DETAILED DESCRIPTION

The following detailed description describes recovery of carbon dioxide from produced water to neutralize liquid brine and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

At a high-level, the described approach relates to a method of capturing a carbon dioxide-rich gas stream that results from the treatment of produced water from oil and gas exploration and production, and utilizing carbon dioxide-rich gas as a form of acid addition to neutralize an alkaline liquid brine stream.

Large volumes of produced water are generated as a by-product of oil and gas exploration and production. A portion of the produced water is minimally treated and recycled for steam generation or water flooding. The excess produced water is often disposed by injection into underground wells.

Due to many challenges associated with injection, there is a need to develop reliable alternate solutions for disposal of produced water and to minimize injection volumes. One option is treatment of produced water for beneficial reuse to minimize injection volumes. Beneficial reuse applications can include, but are not limited to, irrigation and agricultural water, aquifer replenishment, industrial use, and freshwater generation to support oil and gas operations.

When treating produced water for beneficial reuse, a volume of liquid requiring underground injection is reduced, but beneficial reuse processes typically generate a liquid brine stream as a waste by-product that requires injection. In some cases, the liquid brine stream that needs to be injected exists at an alkaline power of hydrogen (pH) condition, requiring neutralization of the liquid brine stream prior to injection to, for example, prevent scaling or corrosion. Neutralization of an alkaline brine requires an acid, which can result in significant additional operating costs in the form of chemical purchases, specifically when the liquid brine stream is highly alkaline and of substantial volume.

Produced water typically contains dissolved gases, including, for example, carbon dioxide and hydrogen sulfide. Produced water also typically contains alkalinity (e.g., in a form of bicarbonate and carbonate ions), and speciation of the total alkalinity within the produced water is a function of the pH of the produced water.

A process for treating produced water for beneficial reuse generally involves removal of contaminants that have the potential for contributing to scale formation, fouling, or corrosion within pipes and biological growth in processing / storage equipment. The process also includes contaminant removal that is required to increase efficiency of specific unit operations within a treatment system. Contaminants can include, for example, alkalinity, hardness, suspended solids, free oil, iron, hardness, silica, and dissolved gases (such as, carbon dioxide, hydrogen sulfide, ammonia, and volatile organic compounds). The process of treating produced water for beneficial reuse also often involves the removal of dissolved solids from the water to meet the requirements for reuse or discharge.

Unless an application is driven to a zero liquid waste solution, treatment of produced water often results in the generation of a concentrated liquid brine stream. This concentrated liquid brine stream must be disposed, typically using injection.

The described approach permits carbon dioxide to be sequestered, instead of releasing it to the atmosphere as a greenhouse gas, and substantially reduces the operating costs of an overall produced water treatment approach by eliminating, or substantially minimizing, a need to procure acid for brine neutralization. The approach also provides for a means of sequestering hydrogen sulfide (and other dissolved gases) that is present in a carbon dioxide-rich gas, thereby eliminating a need to treat the carbon dioxide-rich gas for hydrogen sulfide (and/or other dissolved gas) removal.

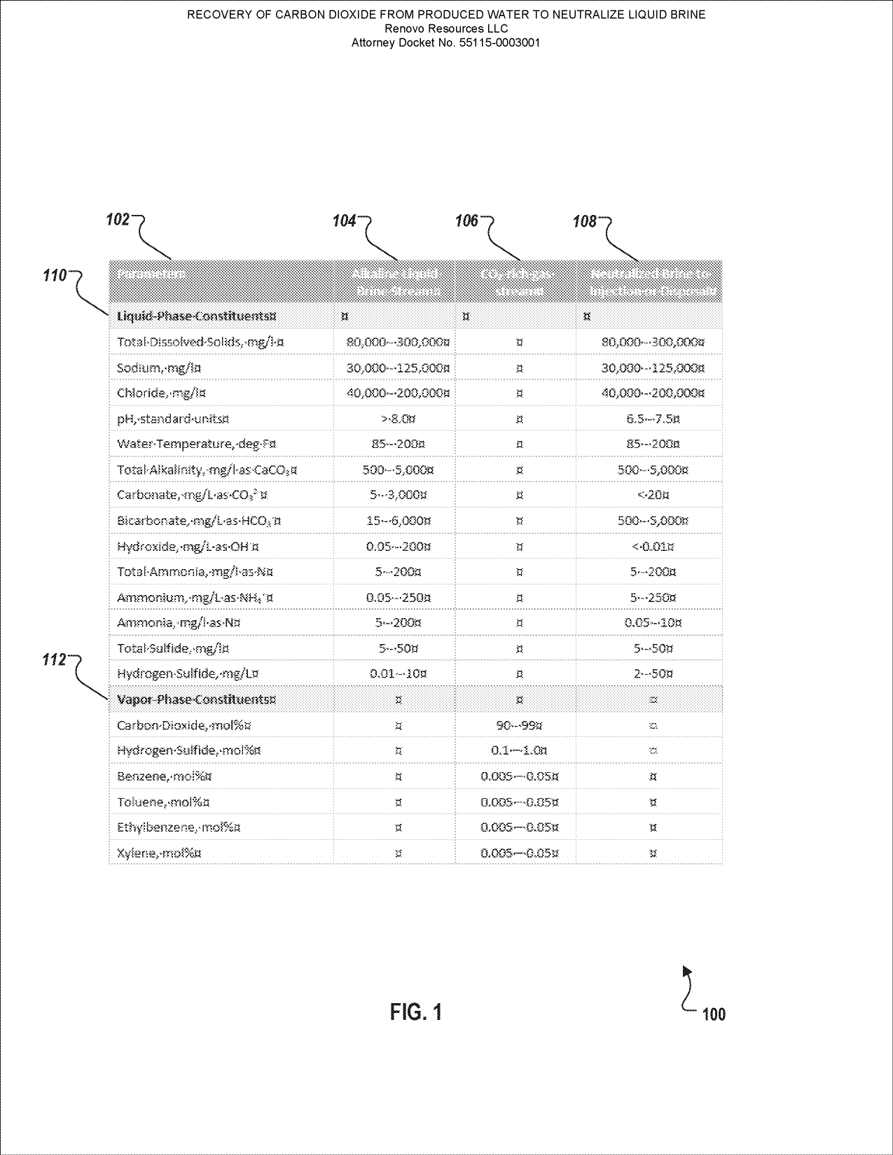

FIG. 1 is a table 100 illustrating an example characterization for an alkaline liquid brine stream, carbon dioxide-rich gas stream, and neutralized brine stream generated from treatment of produced water, according to an implementation of the present disclosure.

Table 100 includes columns for Parameters 102, Alkaline Liquid Brine Stream 104, Carbon Dioxide-rich-gas stream 106, and Neutralized Brine to Injection or Disposal 108. The Parameters 102 is divided into both Liquid-Phase-Constituents 110 and Vapor-Phase-Constituents 112.

Carbon Dioxide-rich-gas stream 106 is an example of characteristics of a carbon dioxide-rich gas stream that could be utilized to neutralize an alkaline liquid brine. Neutralized Brine to Injection or Disposal 108 is an example of characteristics of a neutralized liquid brine stream following injection of the carbon dioxide-rich gas into the alkaline liquid brine stream.

The data included in FIG. 1 is only one example of a range of constituents in these streams, and the present disclosure is not limited to these specific water and gas quality ranges. It should be understood that the concentrations of contaminants can vary for each produced water treatment application.

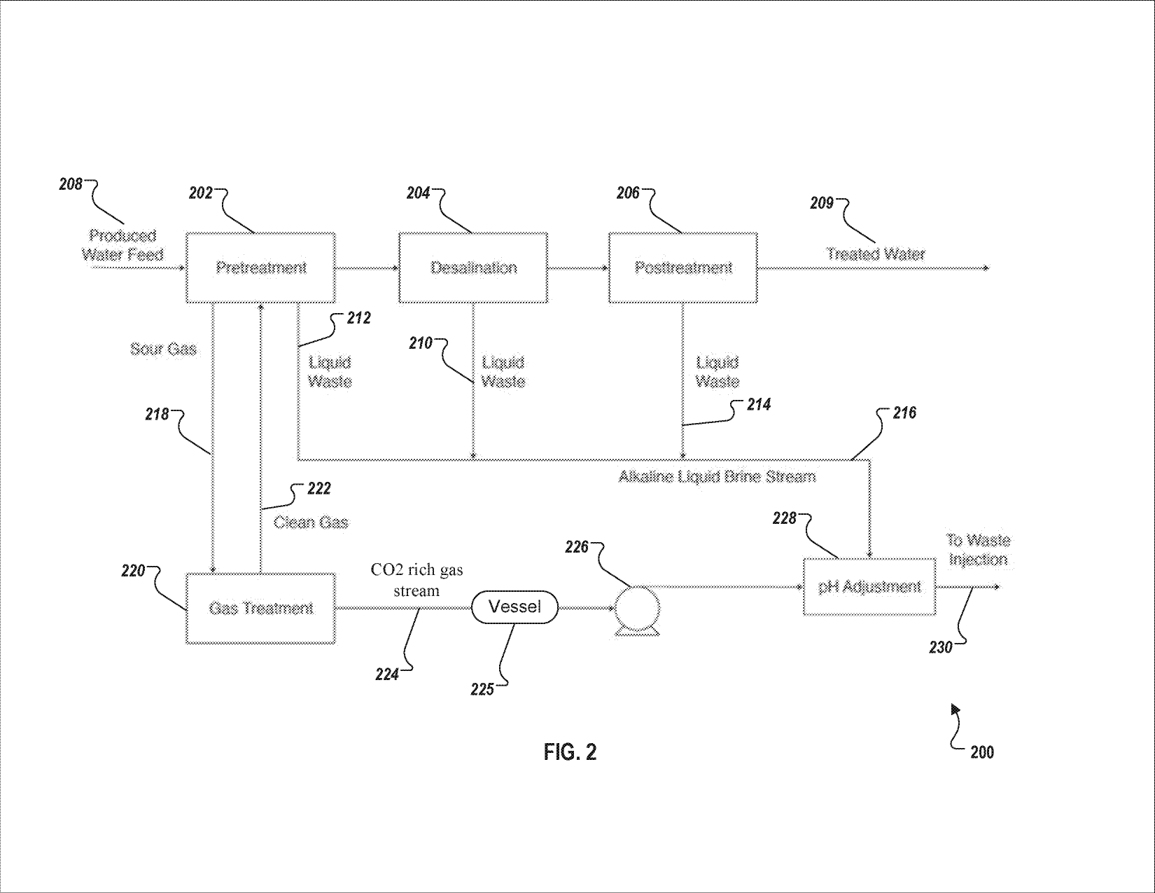

FIG. 2 is a high-level box diagram illustrating a method 200 for utilizing carbon dioxide-rich gas as a neutralizing acid for liquid brine streams generated during the treatment of produced water for beneficial reuse, according to an implementation of the present disclosure.

FIG. 2 illustrates steps for pre-treatment 202, desalination 204, and post-treatment 206. The pretreatment 202 system can include a process to remove dissolved gases from produced water 208. The dissolved gases can include carbon dioxide, as well as other gases (such as, hydrogen sulfide, ammonia, and/or volatile organic compounds). The produced water 208 can include alkalinity in the form of bicarbonate ions, some of which may be converted to dissolved carbon dioxide with the addition of an acid prior to the removal of dissolved gases from a liquid phase. In addition to dissolved gas removal, pre-treatment 202 can also include de-oiling and other processes to removal scale formers and foulants from the produced water. Pre-treatment can also include acidification of the produced water 208 to convert bicarbonate alkalinity to carbon dioxide prior to the removal of dissolved gases from the produced water 208.

In some implementations, desalination 204 will include a membrane-based treatment approach, such reverse osmosis or a thermal treatment approach, such as evaporation, to remove dissolved solids from pretreated water. Desalinated water may then be subjected to additional post-treatment 206 to further reduce concentrations of contaminants from the desalinated water prior to beneficial reuse as treated water 209. Desalination 204 generates a concentrated liquid waste stream 210. Additional liquid waste streams (212 and 214) may be generated in one or both of the pre-treatment 202 or post-treatment 206, respectively. The combination of the liquid waste streams generated in the pretreatment 202, desalination 204, and post-treatment 206 are combined to generate a single alkaline liquid brine stream 216.

In most cases, this sour gas will be treated for contaminant removal within a gas treatment system such that the carrier gas (fuel gas or nitrogen) can be recovered as clean gas for reuse within the produced water treatment process. The gas treatment process generates a carbon dioxide-rich gas stream. This gas may also include hydrogen sulfide and trace concentrations of other contaminants such as volatile organic compounds. Releasing this carbon dioxide-rich gas to the atmosphere would result in an increase in greenhouse gas emissions. Additionally, if hydrogen sulfide and volatile organic compounds are present in the gas, additional vapor-phase treatment is required prior to discharge of the carbon dioxide, resulting in additional complexity and costs. The present invention allows for recovery of a carbon dioxide-rich gas stream to be utilized as the neutralizing acid for the liquid brine stream generated in the process. The invention also allows for hydrogen sulfide and volatile organic compounds to be sequestered along with the carbon dioxide.

The treatment of produced water 208 in pre-treatment 202 results in the generation of an off-gas stream, referred to as sour gas 218. As previously described, dissolved carbon dioxide is one component of the sour gas 218, which also may include hydrogen sulfide, ammonia, and volatile organic compounds. The sour gas 218 is treated in a gas treatment system 220 to achieve contaminant removal and to recover a clean gas 222 stream (e.g., a fuel gas or nitrogen gas). Following gas treatment in the gas treatment system 220, a carbon dioxide-rich gas stream 224 remains as a waste gas and must be handled.

In some implementations, the alkaline liquid brine stream 216 is alkaline with a pH of greater than 8.0. The carbon dioxide-rich gas stream 224 generated from gas treatment 220 is captured and stored in a vessel 225. The carbon dioxide-rich gas stream 224 is then re-pressurized (e.g., using pump 226) and injected into the alkaline liquid brine stream 216 to reduce the pH of the alkaline liquid brine stream 216 to achieve neutralization within the pH range of 6.5 to 7.5.

A system for injection (illustrated as 228) can include one or more of a static mixer, tank, gas diffuser(s), and a pumping system. A continuous pH control loop can be used to control a dosage of carbon dioxide into the alkaline liquid brine stream 216. Following pH adjustment 228, a neutralized liquid brine 230 is disposed of using injection. Carbon dioxide and other dissolved gases, such as hydrogen sulfide and volatile organic compounds, which were present in the produced water are sequestered as a result of the described approach.

Note that, with reference to FIG. 2, an approach designed to treat produced water 208 for beneficial reuse may include systems for pre-treatment 202, desalination 204, and post-treatment 206. The specific components within these systems can vary for each application. Moreover, in some implementations, not all of these systems are required for each application, and a level of treatment required can be dependent on a specific type of beneficial reuse that is required. FIG. 2 illustrates only one possible implementation of a process that could be designed to treat produced water for beneficial reuse. The described approach does not require a specific type of treatment for beneficial reuse, rather it requires recovery of a carbon dioxide-rich gas stream that is generated during treatment of produced water, and generation of a liquid brine stream that requires neutralization prior to injection.

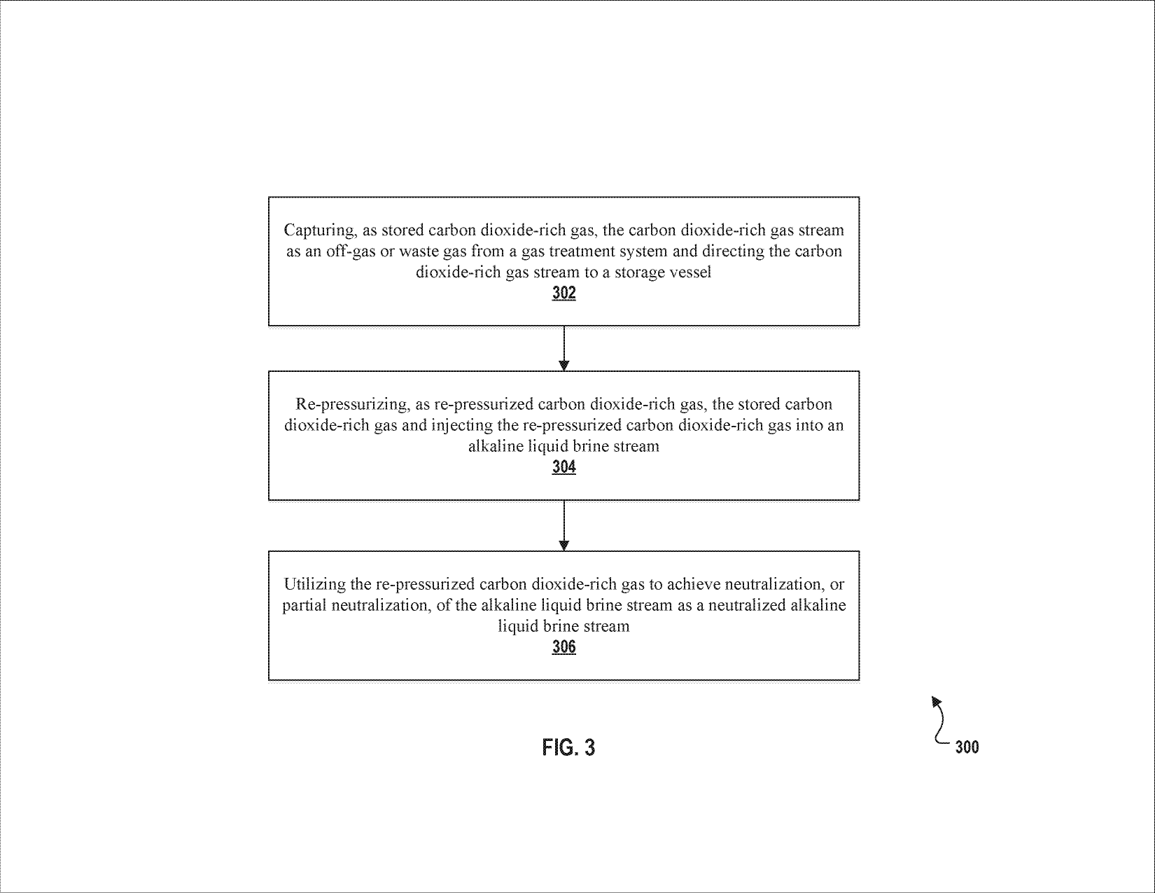

FIG. 3 is a flowchart illustrating an example of a method 300 for recovery of carbon dioxide from produced water to neutralize liquid brine, according to an implementation of the present disclosure. For clarity of presentation, the description that follows generally describes method 300 in the context of the other figures in this description.

At 302, a carbon dioxide-rich gas stream is captured as an off-gas or waste gas from a gas treatment system and directing the carbon dioxide-rich gas stream to a storage vessel. In some implementations, the carbon dioxide-rich gas stream used for neutralization is generated during treatment of produced water. From 302, method 300 proceeds to 304.

At 304, the stored carbon dioxide-rich gas is re-pressurized and injected into an alkaline liquid brine stream. In some implementations, the alkaline liquid brine stream is alkaline with a pH greater than 8.0 prior to introducing the carbon dioxide-rich gas stream. In some implementations, a pH of the alkaline liquid brine stream must be reduced to a range of 6.5 to 7.5 prior to disposal. From 304, method 300 proceeds to 306.

At 306, the re-pressurized carbon dioxide-rich gas is utilized to achieve neutralization, or partial neutralization, of the alkaline liquid brine stream as a neutralized alkaline liquid brine stream. In some implementations, a supplemental source of acid is only used for alkaline liquid brine stream neutralization when a quantity of carbon dioxide-rich gas stream generated from treatment of produced water is not great enough to achieve complete neutralization. In some implementations, neutralization within the alkaline liquid brine stream, due to addition of the re-pressurized carbon dioxide-rich gas, includes reaction of all forms of alkalinity in the alkaline liquid brine stream, including hydroxide, carbonate, ammonia, borate, silicate, and organics to generate bicarbonate ions or conjugate acids of bases that are contributing to total alkalinity. In some implementations, the neutralized alkaline liquid brine stream is suitable for injection. After 306, method 300 can stop.

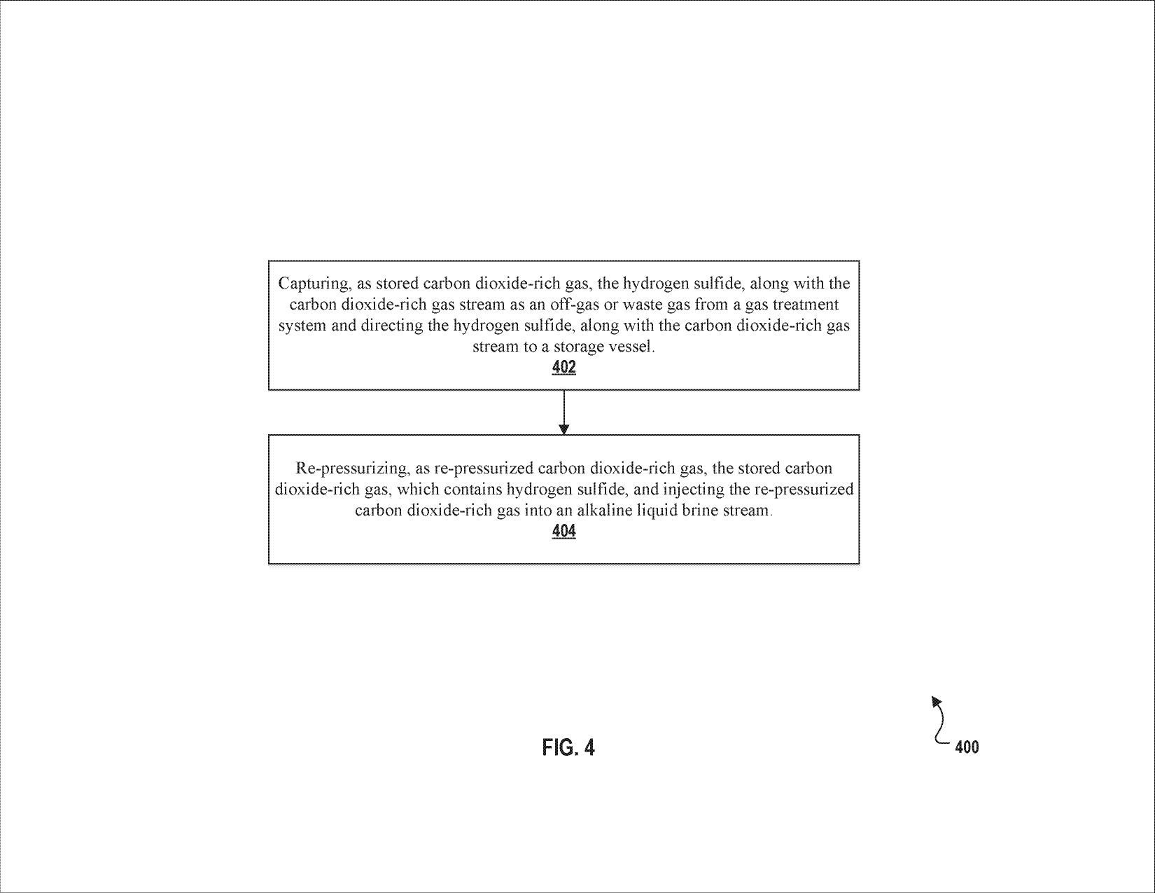

FIG. 4 is a flowchart illustrating an example of a method 400 for recovery of carbon dioxide and hydrogen sulfide from produced water to neutralize liquid brine, according to an implementation of the present disclosure. For clarity of presentation, the description that follows generally describes method 400 in the context of the other figures in this description.

At 402, a carbon dioxide-rich gas stream containing hydrogen sulfide is captured as an off-gas or waste gas from a gas treatment system and directed to a storage vessel. In some implementations, the carbon dioxide-rich gas stream, which contains hydrogen sulfide, is generated during treatment of produced water. From 402, method 400 proceeds to 404.

At 404, the stored carbon dioxide-rich gas, which contains hydrogen sulfide, is re-pressurized and injected into an alkaline liquid brine stream. In some implementations, the re-pressurized carbon dioxide-rich gas, which contains hydrogen sulfide, is utilized as a neutralizing acid for an alkaline liquid brine stream prior to injection. In some implementations, a neutralized alkaline liquid brine stream is suitable for injection. After 404, method 400 can stop.

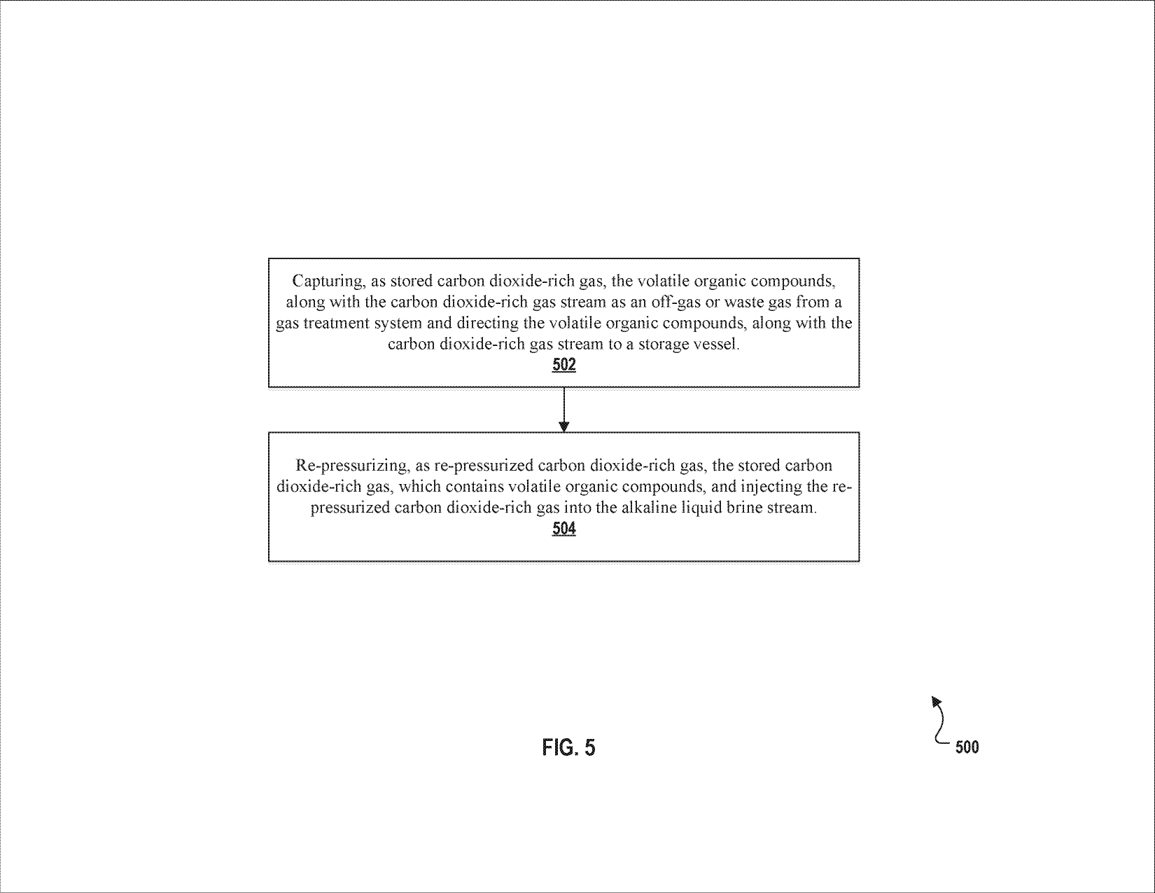

FIG. 5 is a flowchart illustrating an example of a method 500 for recovery of carbon dioxide and volatile organic compounds from produced water to neutralize liquid brine, according to an implementation of the present disclosure. For clarity of presentation, the description that follows generally describes method 500 in the context of the other figures in this description.

At 502, carbon dioxide-rich gas containing volatile organic compounds is captured as an off-gas or waste gas from a gas treatment system and directed to a storage vessel. In some implementations, the carbon dioxide-rich gas stream, which contains volatile organic compounds, is generated during treatment of produced water. From 502, method 500 proceeds to 504.

At 504, the stored carbon dioxide-rich gas, which contains volatile organic compounds, is re-pressurized and injected into the alkaline liquid brine stream. In some implementations, the re-pressurized carbon dioxide-rich gas, which contains volatile organic compounds, is utilized as a neutralizing acid for the alkaline liquid brine stream prior to injection. In some implementations, a neutralized alkaline liquid brine stream is suitable for injection. After 504, method 500 can stop.

Described implementations of the subject matter can include one or more features, alone or in combination.

For example, in a first implementation, a method of utilizing a carbon dioxide-rich gas stream, generated during treatment of produced water, to neutralize an alkaline liquid brine stream, comprising: capturing, as stored carbon dioxide-rich gas, the carbon dioxide-rich gas stream as an off-gas or waste gas from a gas treatment system and directing the carbon dioxide-rich gas stream to a storage vessel; re-pressurizing, as re-pressurized carbon dioxide-rich gas, the stored carbon dioxide-rich gas and injecting the re-pressurized carbon dioxide-rich gas into an alkaline liquid brine stream; and utilizing the re-pressurized carbon dioxide-rich gas to achieve neutralization, or partial neutralization, of the alkaline liquid brine stream as a neutralized alkaline liquid brine stream.

The foregoing and other described implementations can each, optionally, include one or more of the following features:

A first feature, combinable with any of the following features, wherein the alkaline liquid brine stream is alkaline with a power of hydrogen (pH) greater than 8.0 prior to introducing the carbon dioxide-rich gas stream.

A second feature, combinable with any of the previous or following features, wherein a power of hydrogen (pH) of the alkaline liquid brine stream must be reduced to a range of 6.5 to 7.5 prior to disposal.

A third feature, combinable with any of the previous or following features, wherein the carbon dioxide-rich gas stream used for neutralization is generated during treatment of produced water.

A fourth feature, combinable with any of the previous or following features, wherein a supplemental source of acid is only used for alkaline liquid brine stream neutralization when a quantity of carbon dioxide-rich gas stream generated from treatment of produced water is not great enough to achieve complete neutralization.

A fifth feature, combinable with any of the previous or following features, wherein neutralization within the alkaline liquid brine stream, due to addition of the re-pressurized carbon dioxide-rich gas, includes reaction of all forms of alkalinity in the alkaline liquid brine stream, including hydroxide, carbonate, ammonia, borate, silicate, and organics to generate bicarbonate ions or conjugate acids of bases that are contributing to total alkalinity.

A sixth feature, combinable with any of the previous or following features, wherein the neutralized alkaline liquid brine stream is suitable for injection.

In a second implementation, a method of sequestering hydrogen sulfide that is present in a carbon dioxide-rich gas stream that is utilized for neutralization of an alkaline liquid brine stream, comprising: capturing, as stored carbon dioxide-rich gas, the hydrogen sulfide, along with the carbon dioxide-rich gas stream as an off-gas or waste gas from a gas treatment system and directing the hydrogen sulfide, along with the carbon dioxide-rich gas stream to a storage vessel; and re-pressurizing, as re-pressurized carbon dioxide-rich gas, the stored carbon dioxide-rich gas, which contains hydrogen sulfide, and injecting the re-pressurized carbon dioxide-rich gas into an alkaline liquid brine stream.

The foregoing and other described implementations can each, optionally, include one or more of the following features:

A first feature, combinable with any of the following features, wherein the carbon dioxide-rich gas stream, which contains hydrogen sulfide, is generated during treatment of produced water.

A second feature, combinable with any of the previous or following features, wherein the re-pressurized carbon dioxide-rich gas, which contains hydrogen sulfide, is utilized as a neutralizing acid for an alkaline liquid brine stream prior to injection.

A third feature, combinable with any of the previous or following features, wherein a neutralized alkaline liquid brine stream is suitable for injection.

In a third implementation, a method of sequestering volatile organic compounds that are present in a carbon dioxide-rich gas stream that is utilized for neutralization of an alkaline liquid brine stream, comprising: capturing, as stored carbon dioxide-rich gas, the volatile organic compounds, along with the carbon dioxide-rich gas stream as an off-gas or waste gas from a gas treatment system and directing the volatile organic compounds, along with the carbon dioxide-rich gas stream to a storage vessel; and re-pressurizing, as re-pressurized carbon dioxide-rich gas, the stored carbon dioxide-rich gas, which contains volatile organic compounds, and injecting the re-pressurized carbon dioxide-rich gas into the alkaline liquid brine stream.

The foregoing and other described implementations can each, optionally, include one or more of the following features:

A first feature, combinable with any of the following features, wherein the carbon dioxide-rich gas stream, which contains volatile organic compounds, is generated during treatment of produced water.

A second feature, combinable with any of the previous or following features, wherein the re-pressurized carbon dioxide-rich gas, which contains volatile organic compounds, is utilized as a neutralizing acid for the alkaline liquid brine stream prior to injection.

A third feature, combinable with any of the previous or following features, wherein a neutralized alkaline liquid brine stream is suitable for injection.

What is claimed is:

1. A method of utilizing a carbon dioxide-rich gas stream, generated during treatment of produced water, to neutralize an alkaline liquid brine stream, comprising:
capturing, as stored carbon dioxide-rich gas, the carbon dioxide-rich gas stream as an off-gas or waste gas from a gas treatment system and directing the carbon dioxide-rich gas stream to a storage vessel;
re-pressurizing, as re-pressurized carbon dioxide-rich gas, the stored carbon dioxide-rich gas and injecting the re-pressurized carbon dioxide-rich gas into an alkaline liquid brine stream; and
utilizing the re-pressurized carbon dioxide-rich gas to achieve neutralization, or partial neutralization, of the alkaline liquid brine stream as a neutralized alkaline liquid brine stream.

2. The method of claim 1, wherein the alkaline liquid brine stream is alkaline with a power of hydrogen (pH) greater than 8.0 prior to introducing the carbon dioxide-rich gas stream.

3. The method of claim 1, wherein a power of hydrogen (pH) of the alkaline liquid brine stream must be reduced to a range of 6.5 to 7.5 prior to disposal.

4. The method of claim 1, wherein the carbon dioxide-rich gas stream used for neutralization is generated during treatment of produced water.

5. The method of claim 1, wherein a supplemental source of acid is only used for alkaline liquid brine stream neutralization when a quantity of carbon dioxide-rich gas stream generated from treatment of produced water is not great enough to achieve complete neutralization.

6. The method of claim 1, wherein neutralization within the alkaline liquid brine stream, due to addition of the re-pressurized carbon dioxide-rich gas, includes reaction of all forms of alkalinity in the alkaline liquid brine stream, including hydroxide, carbonate, ammonia, borate, silicate, and organics to generate bicarbonate ions or conjugate acids of bases that are contributing to total alkalinity.

7. The method of claim 1, wherein the neutralized alkaline liquid brine stream is suitable for injection.

8. A method of sequestering hydrogen sulfide that is present in a carbon dioxide-rich gas stream that is utilized for neutralization of an alkaline liquid brine stream, comprising:
capturing, as stored carbon dioxide-rich gas, the hydrogen sulfide, along with the carbon dioxide-rich gas stream as an off-gas or waste gas from a gas treatment system and directing the hydrogen sulfide, along with the carbon dioxide-rich gas stream to a storage vessel; and
re-pressurizing, as re-pressurized carbon dioxide-rich gas, the stored carbon dioxide-rich gas, which contains hydrogen sulfide, and injecting the re-pressurized carbon dioxide-rich gas into an alkaline liquid brine stream.

9. The method of claim 8, wherein the carbon dioxide-rich gas stream, which contains hydrogen sulfide, is generated during treatment of produced water.

10. The method of claim 8, wherein the re-pressurized carbon dioxide-rich gas, which contains hydrogen sulfide, is utilized as a neutralizing acid for an alkaline liquid brine stream prior to injection.

11. The method of claim 8, wherein a neutralized alkaline liquid brine stream is suitable for injection.

12. A method of sequestering volatile organic compounds that are present in a carbon dioxide-rich gas stream that is utilized for neutralization of an alkaline liquid brine stream, comprising:
capturing, as stored carbon dioxide-rich gas, the volatile organic compounds, along with the carbon dioxide-rich gas stream as an off-gas or waste gas from a gas treatment system and directing the volatile organic compounds, along with the carbon dioxide-rich gas stream to a storage vessel; and
re-pressurizing, as re-pressurized carbon dioxide-rich gas, the stored carbon dioxide-rich gas, which contains volatile organic compounds, and injecting the re-pressurized carbon dioxide-rich gas into the alkaline liquid brine stream.

13. The method of claim 12, wherein the carbon dioxide-rich gas stream, which contains volatile organic compounds, is generated during treatment of produced water.

14. The method of claim 12, wherein the re-pressurized carbon dioxide-rich gas, which contains volatile organic compounds, is utilized as a neutralizing acid for the alkaline liquid brine stream prior to injection.

15. The method of claim 12, wherein a neutralized alkaline liquid brine stream is suitable for injection.
